(19) United States
(12) Patent Application Publication
(10) Pub. No.: US 2007/0209016 A1
(43) Pub. Date: Sep. 6, 2007

(54) Character input technique without a keyboard

(75) Inventors: Takaharu Takayama, Kageshima-shi (JP); Shinji Ehara, Oita-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/657,776

(22) Filed: Jan. 24, 2007

(30) Foreign Application Priority Data
Jan. 25, 2006 (JP) 2006-15789

(51) Int. Cl. G06F 3/048; G09G 5/00

(52) U.S. Cl. 715/780; 345/156

(57) ABSTRACT

A technology to input a character without a keyboard is provided. A character input screen 400 for performing character input is displayed on a display device. On this character input screen 400 is provided an input character selection field 510, with the characters displayed in the input character selection field 510 being cyclically switched. When the user instructs character input, the character currently displayed in the input character selection field 510 is acquired as the character for input.

### CROSS-REFERENCE TO RELATED APPLICATIONS

The present application claims the priority based on Japanese Patent Application No. 2006-15789 filed on Jan. 25, 2006, the disclosure of which is hereby incorporated herein by reference in its entirety.

### BACKGROUND OF THE INVENTION

1. Field of the Invention

The present invention relates to technology for inputting a character without a keyboard.

2. Description of the Related Art

In a device such as a digital television set or a video game machine, an input device such as a remote controller or game pad is typically used as the device for the user to input an instruction into the device. The number of buttons (keys) provided to a remote controller or similar input device is fewer than the number of keys provided to a keyboard for inputting characters. Consequently, a software keyboard is used in order to input characters with a remote controller or similar device, for example. The software keyboard displays an image of keyboard on a screen, and moves the cursor over the keys displayed on the screen, in order to input the characters.

With a software keyboard of this kind, the user may be required to perform numerous operations, such as operations to continuously push direction buttons on the remote controller or similar device in order to move the cursor, and operations to instruct input of a character with the cursor positioned over the location of the desired character.

### SUMMARY OF THE INVENTION

An object of the present invention is to provide technology for facilitating input of a character without a keyboard.

According to an aspect of the present invention, a method for inputting a character is provided. The method comprising the steps of: (a) displaying a character input screen on a display device, the character input screen having an input character selection field for showing one or more characters which are selectable to input a character; (b) cyclically switching the one or more characters being displayed in the input character selection field; (c) receiving a character input instruction from user; and (d) acquiring the character being displayed in the input character selection field as an input character upon reception of the character input instruction.

In this arrangement, the user can input a desired character displayed in the input character selection field, simply by instructing character input when the character in the input character selection field has switched to the desired character. Consequently, it is possible to reduce the number of operations for inputting a character, and the user may enter a character easier.

The present invention may be reduced to practice in various forms. For example, the invention can take various embodiments such as a character input device and character input method; a computer program for realizing the functions of such a character input device or character input method; a recording medium having such a computer program recorded thereon; a data signal containing such a computer program and embodied in a carrier wave; and so on.

These and other objects, features, aspects, and advantages of the present invention will become more apparent from the following detailed description of the preferred embodiments with the accompanying drawings.

### BRIEF DESCRIPTION OF THE DRAWINGS

FIG. 1 illustrates an arrangement of a network system as a first embodiment of the present invention.

FIG. 2 show a functional block diagram depicting the functional arrangements of the digital TV 100 and the network adapter 200.

FIG. 3 is a flowchart of the character input routine in the first embodiment.

FIG. 4 is a flowchart depicting an input character acquisition subroutine.

FIGS. 5(a) through 5(d) illustrate a situation while a character is input in the first embodiment.

FIG. 6 is a flowchart of the character input routine in the second embodiment

FIG. 7 is a flowchart depicting the character group selection subroutine.

FIGS. 8(a) through 8(d) illustrate a situation while a character is input in the second embodiment.

FIGS. 9(a) through 9(c) illustrate a situation while a character is input in the third embodiment.

FIGS. 10(a) through 10(d) illustrate a situation while a character is input in the fourth embodiment.

FIG. 11 is a flowchart of the character input routine in the fifth embodiment.

FIG. 12 is a flowchart depicting the input character acquisition subroutine in the fifth embodiment.

FIGS. 13(a) through 13 (d) illustrate changing of the character input location.

### DESCRIPTION OF THE PREFERRED EMBODIMENT

Embodiments of the present invention will now be described in the following sequence.

A. First Embodiment:

B. Second Embodiment:

C. Third Embodiment:

D. Fourth Embodiment:

E. Fifth Embodiment:

F. Variations:

### A. First Embodiment

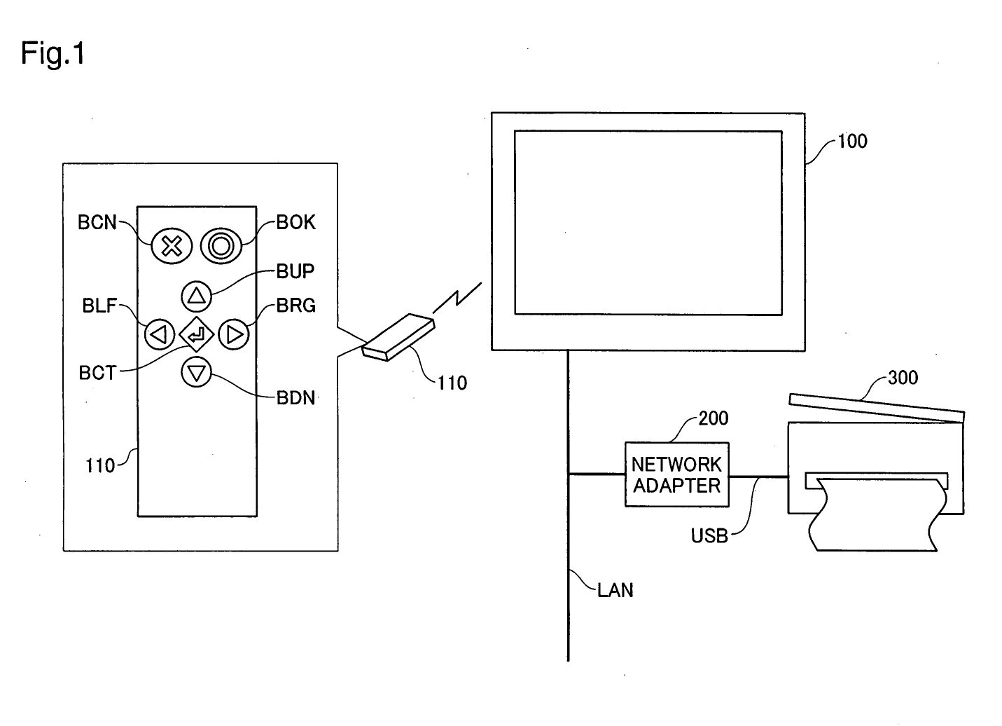

FIG. 1 illustrates an arrangement of a network system as a first embodiment of the present invention. In this network system, a digital TV 100 and a network adapter 200 are connected through a local area network (LAN). A scanner/printer/copier multifunction device 300 (hereinafter simply termed “multifunction device 300”) is connected to the network adapter 200 by a Universal Serial Bus (USB).

The user of the digital TV 100 issues instructions to the digital TV 100 by pressing buttons furnished to a remote controller 110. The remote controller 110 sends a signal according to the button operated by the user to the digital TV 100. The digital TV 100 executes various type of processing based on the signal received from the remote controller 110.

The remote controller 110 depicted in FIG. 1 is furnished with an OK button BOK, a Cancel button BCN, an Up button BUP, a Down button BDN, a Right button BRG, a Left button BLF, and a Center button BCT. The remote controller 110 is also furnished with other buttons such as channel buttons for changing channels and volume buttons for adjusting the volume, but these buttons are omitted from the illustration.

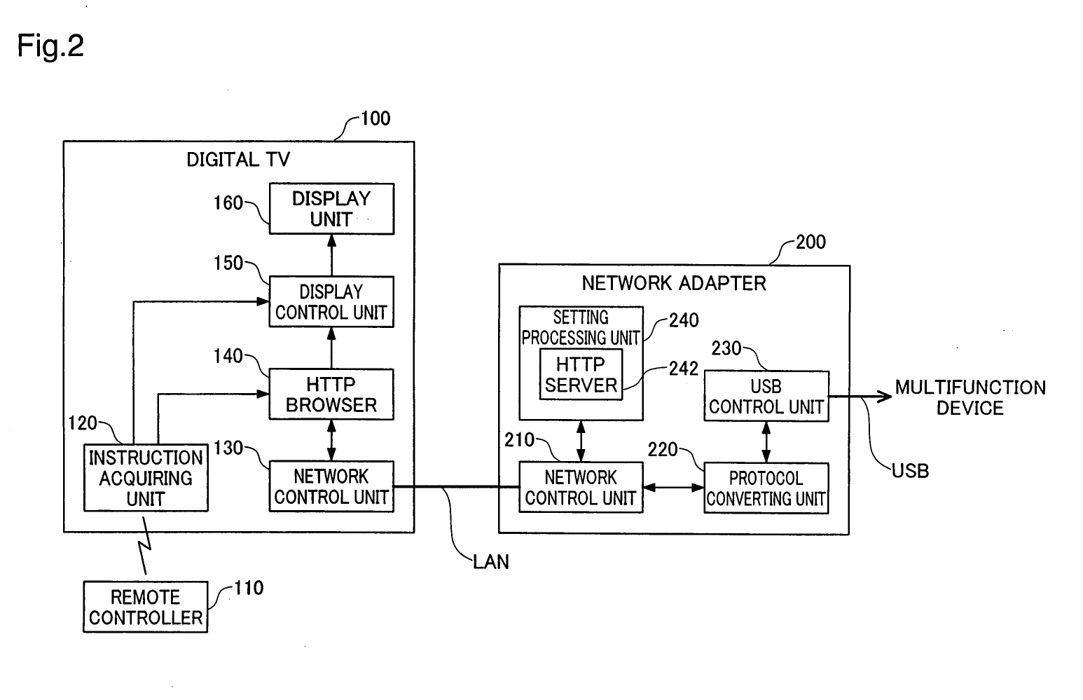

FIG. 2 show a functional block diagram depicting the functional arrangements of the digital TV 100 and the network adapter 200. As shown in FIG. 2, the digital TV 100 has an instruction acquiring unit 120, a network control unit 130, an HTTP browser 140, a display control unit 150, and a display unit 160. The network adapter 200 has a network control unit 210, a setting processing unit 240, a protocol converting unit 220, and a USB control unit 230.

A user's instruction represented by a signal sent from the remote controller 110 to the digital TV 100 is acquired by the instruction acquiring unit 120. The user's instruction acquired by the instruction acquiring unit 120, depending on the type of the instruction, is supplied to the HTTP browser 140 or the display control unit 150.

The display control unit 150 generates image data according to the supplied instruction, and supplies the data to the display unit 160. In the event that, for example, the user's instruction acquired by the instruction acquiring unit 120 is an instruction to display a menu, the display control unit 150 generates image data representing the menu and supplies the image data to the display unit 160. The display unit 160 displays an image on the digital TV 100 screen according to the supplied image data.

The HTTP browser 140 exchanges Hyper Text Transfer Protocol (HTTP) messages with devices connected via the network control unit 130 and the LAN. The HTTP browser 140 interprets Hyper Text Markup Language (HTML) data contained in a received message which is described in HTML. An instruction to display an image (HTML page) represented by the HTML data on the display unit 160 is then supplied to the display control unit 150.

The protocol converting unit 220 of the network adapter 200 performs conversion between the protocol for sending/receiving messages via the network control unit 210 and the LAN, and the protocol for transferring data to and from the multifunction device 300 connected via the USB control unit 230. Since the present invention does not relates to the arrangement or the function of the protocol converting unit 220 and the USB control unit 230, these units will not be discussed herein.

The setting processing unit 240 performs various setting of the network adapter 200. The setting processing unit 240 has an HTTP server 242. The setting processing unit 240 exchanges prescribed messages between the HTTP server 242 and the HTTP browser 140 connected via the LAN. Settings such as a network name and an IP address of the network adapter 200 for identifying the network adapter 200 on the network are set in this way.

In the example of FIG. 2, the network adapter 200 and the digital TV 100 are connected via the LAN. Accordingly, settings such as the IP address of the network adapter 200 are set by exchanging setting messages between the HTTP server 242 and the HTTP browser 140.

Specifically, settings for the network adapter 200 are set in the following manner. First, the user operates the digital TV 100 to access the HTTP server 242 of the network adapter 200, and displays a Setting HTML page (Setting page) on the display unit 160. Where the digital TV 100 and the network adapter 200 are both configured as Universal Plug and Play (UPnP; UPnP is a trademark of the UPnP Implementers Corporation) compliant network devices, display of the Setting page can be accomplished by acquiring the presentation page of the network adapter 200.

When transferring the HTML data representing the Setting page to the HTTP browser 140, the HTTP server 242 embeds a program in the data for making the HTTP browser 140 to execute a character input routine, described later. With the remote controller 110, the user issues an instruction to the HTTP browser 140 which executes this character input routine for inputting a character string to be used in setting of the network adapter 200. This type of program embedded in HTML data for making the HTTP browser 140 to execute a prescribed routine is called an “applet” or “script.”

Next, the HTTP browser 140 transfers the HTML data containing the user-input text string (settings instruction form) to the HTTP server 242. The transferred settings instruction form is parsed by the HTTP server 242, and the text string input by the user is extracted. The setting processing unit 240 carries out setting of the network adapter in accordance with the extracted text string.

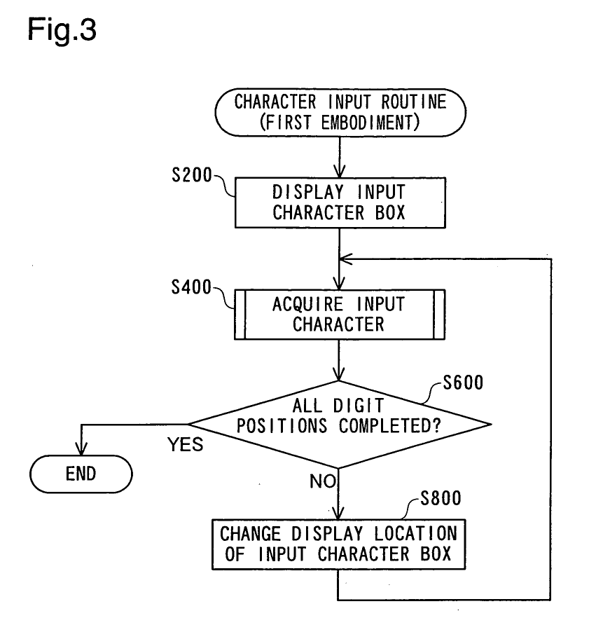

FIG. 3 is a flowchart of the character input routine in the first embodiment. This routine is executed, for example, when the user sets the IP address of the network adapter 200. This character input routine is executed by causing the HTTP browser 140 to run an applet embedded in the HTML data for setting the IP address, transferred from the HTTP server 242.

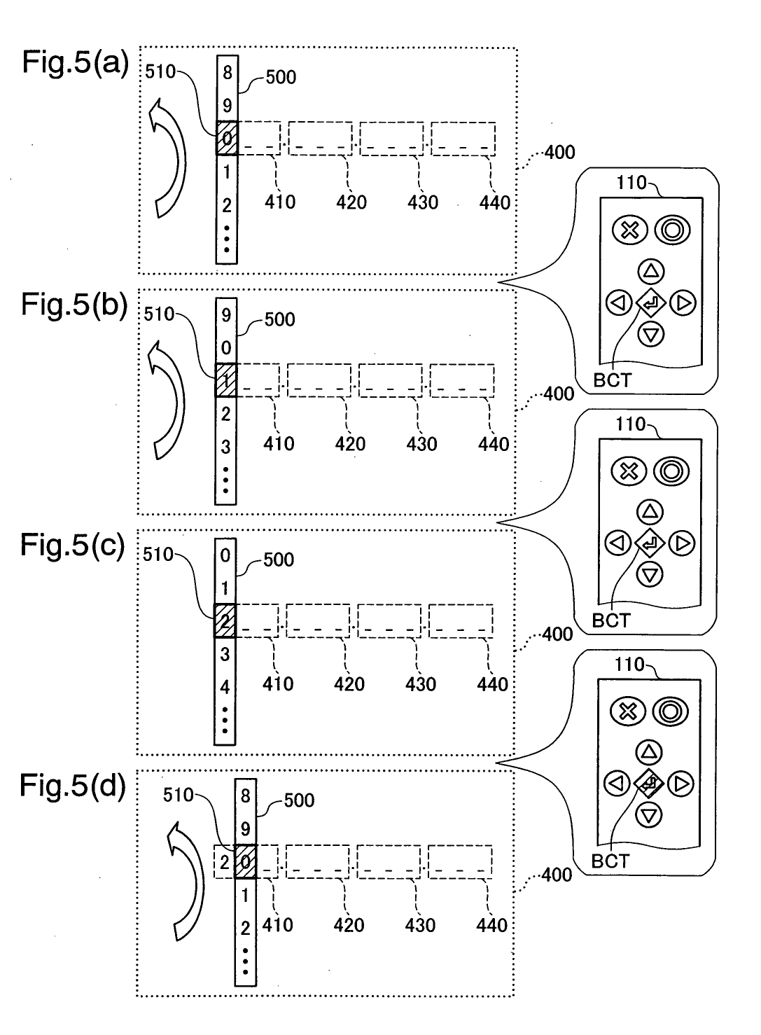

FIGS. 5(a) through 5(d) illustrate a situation while a character is input in the first embodiment. In FIGS. 5(a)˜5(d), a character input page 400 for inputting the IP address is shown. The character input page 400 of the first embodiment has four character input fields 410˜440, for inputting an IP address in a format of four numeral strings separated by dots (.). The character input page 400 displayed on the display unit 160 can also be referred to as a character input screen for inputting characters.

In Step S200 of FIG. 3, the HTTP browser 140 displays an input character box 500 on the character input page 400. In the example of FIG. 5(a), the input character box 500 is displayed so as to overlap the position of the leftmost digit of the character input field 410. Characters from 0 to 9 are displayed in the input character box 500. The overlapping zone 510 of the character input field 410 and the input character box 500 denoted by hatching in FIG. 5(a) (hereinafter termed the “input window 510”) is enclosed at its perimeter by a frame identifying the input window. In the first embodiment, the input window 510 is displayed at the position of the leftmost digit of the character input field 410, which is the character input location. It is also possible for the input window 510 to be displayed at a location other than the character input location instead.

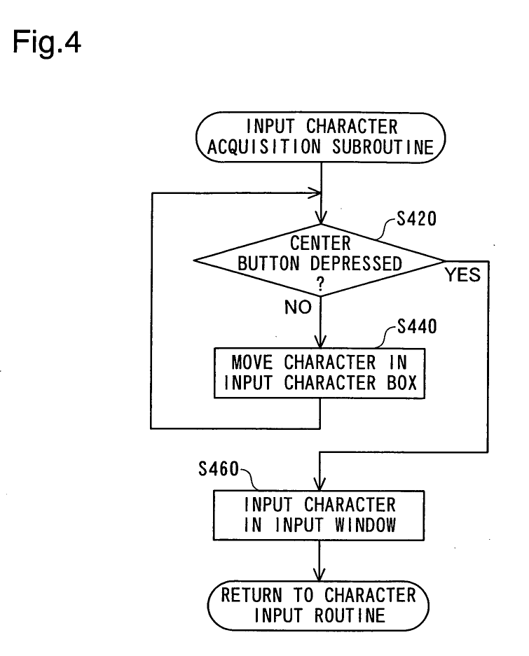

In Step S400 of FIG. 3, an input character acquisition process is carried out. FIG. 4 is a flowchart depicting an input character acquisition subroutine, executed in Step S400 of FIG. 3.

In Step S420 of FIG. 4, the HTTP browser 140 determines whether the Center button BCT of the remote controller 110 (FIG. 1) is depressed. In the event of a determination that the Center button BCT is depressed, the process moves to Step S460. In the event of a determination that the Center button BCT has not been depressed, the process advances to Step S440. In Step S440, the HTTP browser 140 moves the characters in the input character box 500. Step S420 and Step S440 are then executed repeatedly until the Center button BCT is depressed.

In the example of FIGS. 5(a)˜5(d), the user has not depressed the Center button BCT in the time between the states shown in FIGS. 5(a)˜5(c). Consequently, the characters inside the input character box 500 continue to move sequentially upward. This upward movement of the characters in the input character box 500 is accomplished by upward scrolling of the characters in the input character box 500; images running out from the upper edge of the input character box 500 with scrolling will be displayed again starting from the lower edge of the input character box 500

By moving the characters in this way, the input character box 500 appears to the user to spin from bottom to top. Accordingly, this cyclical movement of characters in the input character box 500 shall herein be referred to as “spinning” of the input character box 500 as well. In preferred practice, spinning of the input character box 500 will take place at intermittent intervals after each character briefly halts at a location at the center of the input window, so as to permit the user to reliably input the desired character.

When it is determined that the Center button BCT is depressed in Step S420 of FIG. 4, in Step S460 the character currently inside the input window 510 (FIGS. 5(a)˜5(d)) is entered into the appropriate input field 410˜440. Subsequently, the input character acquisition subroutine shown in FIG. 4 terminates, and control returns to the character input routine of FIG. 3. In the example of FIGS. 5(a)˜5(d), the user has depressed the Center button BCT of the remote controller 110 at a time between the states depicted in FIG. 5(c) and FIG. 5(d). Consequently, the numeric character “2” is entered in the leftmost position of the input field 410, where the input window 510 is currently located. Since the character currently displayed in the input window 510 at the time that the user makes a character input instruction by pressing the Center button BCT will be selected and acquired as the character for input, the input window 510 can also be termed a “character select field.”

In Step S600 of FIG. 3, the HTTP browser 140 determines whether characters are entered at all of the digit positions of the input fields 410˜440. In the event of a determination that characters are entered at all of the digit positions in the input fields 410˜440, the character input routine shown in FIG. 3 terminates. If on the other hand it is determined that characters have not yet been entered at all of the digit positions in the input fields 410˜440, the process advances to Step S800.

In Step S800, the display location of the input character box 500 is changed. Specifically, as depicted in FIG. 5(c) and FIG. 5(d), the input character box 500 moves to the digit position for input of the next character. Once the display location of the input character box 500 is changed in Step S800, the process returns to Step S400. Steps S400˜S800 are then executed repeatedly, until characters are entered at all of the digit positions in the input fields 410˜440.

In this way, according to the first embodiment, characters shown in the input window 510 are cyclically switched by spinning the input character box 500. The user may enter a desired character, by pressing the Center button BCT of the remote controller 110 during the time that the character appearing in the input window 510 is the character desired to input. Since the number of user's operations of the remote controller 110 in order to input characters can be reduced thereby, character input with the remote controller 110 becomes easier.

In the first embodiment, only the numeric characters “0” to “9” are displayed in the input character box 500, for the purpose of inputting the IP address. Thus, the characters for input by user are limited to the numerals “0” to “9.” In the first embodiment, it is accordingly possible in this way to limit characters for input to those characters allowed to be input, and thus to dispense with a process for determining whether an input character is an allowable character. Since in the first embodiment the characters for input are the numeric characters “0” to “9,” these numeric characters constitute the candidate characters for input.

In the first embodiment, once the character input routine of FIG. 3 is executed, the input character box 500 (FIGS. 5(a)˜5(d)) begins to spin without first acquiring of a user's instruction. It is also possible for spinning of the input character box 500 to be initiated based on a user's instruction. For example, spinning of the input character box 500 may be initiated by depressing the Up button BUP or the Down button BDN of the remote controller 110 (FIG. 1). In this case, the spinning speed of the input character box 500 spins may be adjusted by the user. The spinning speed of the input character box 500 may be increased in association with depression of the Up button BUP or the Down button BDN for a longer time.

### B. Second Embodiment

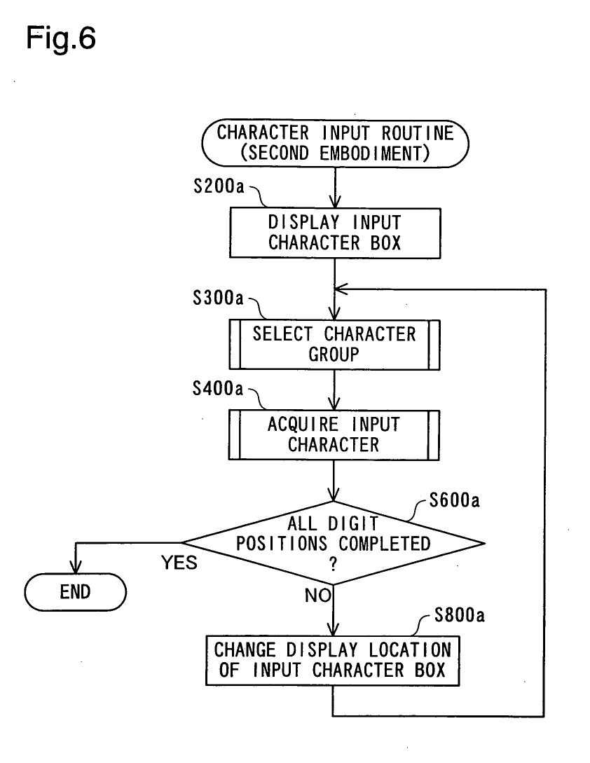

FIG. 6 is a flowchart of the character input routine in the second embodiment. The character input routine in the second embodiment depicted in FIG. 6 differs from the character input routine in the first embodiment in that there is an additional Step S300a of selecting a character group. In other respects it is the same as the first embodiment.

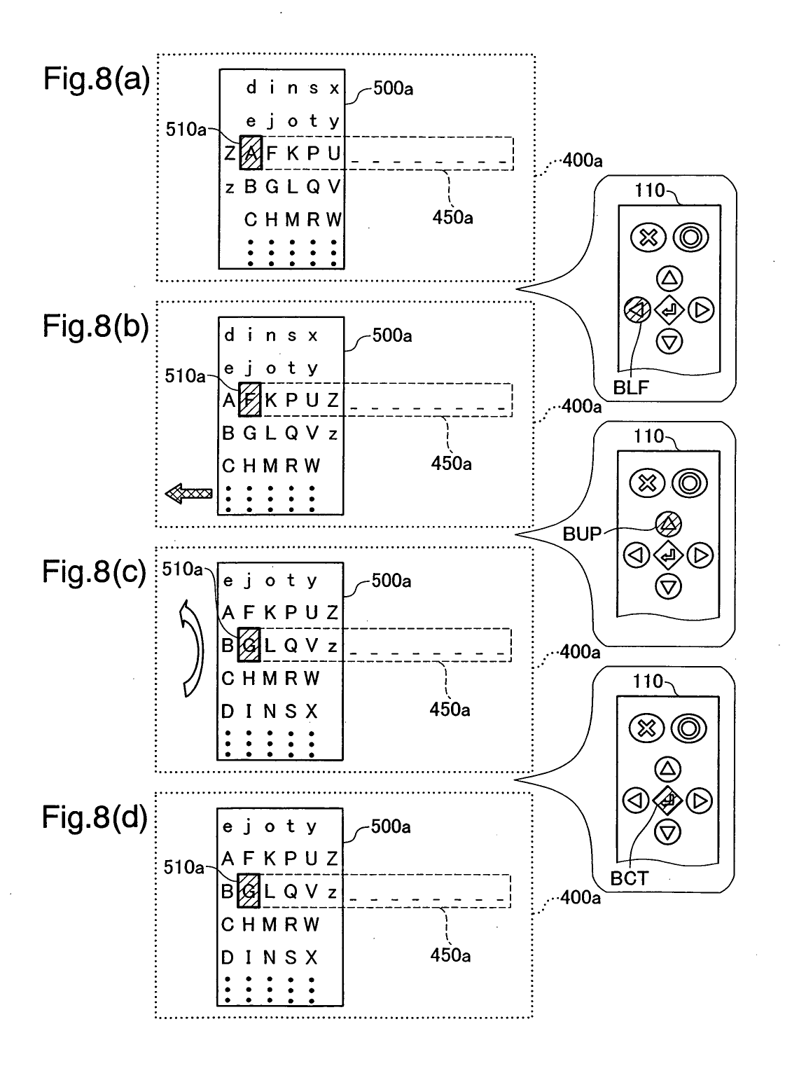

FIGS. 8(a) through 8(d) illustrate a situation while a character is input in the second embodiment. The character input page 400a shown in FIGS. 8(a)˜8(d) has a 13-digit character input field 450a. As shown in FIG. 8 (a), in the second embodiment, the alphabet is divided into six groups, with the groups arrayed in the horizontal direction of the input character box 500a.

Upper case letters and lower case letters are sequenced in alphabetical order in each character group, in the vertical direction of the input character box 500a. Specifically, in the second column from the left of the input character box 500a, letters are sequenced in the order “ABCDEabcde.” The sequence in the vertical direction may consist of a sequence of the same letters of the alphabet, alternating between upper case and lower case. In this case, the second column from the left of the input character box 500a contains letters in the sequence “AaBbCcDdEe.” In the case that the characters for input are either upper case or lower case, the letters of the alphabet may be exclusively upper case or lower case.

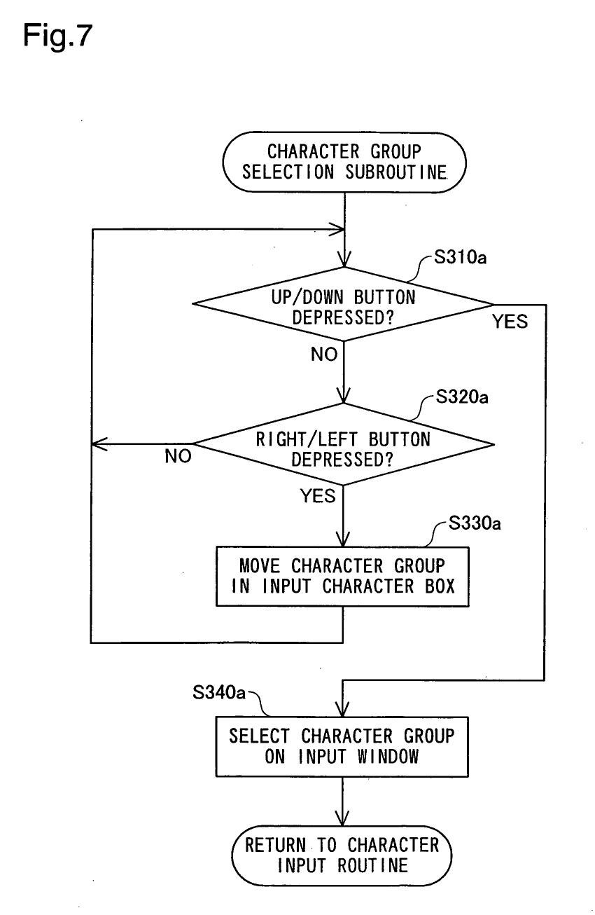

In Step S300a of FIG. 6, a character group selection process is carried out. FIG. 7 is a flowchart depicting the character group selection subroutine executed in Step S300a of FIG. 6.

In Step S310a of FIG. 7, the HTTP browser 140 determines whether either the Up button BUP or the Down button BDN (hereinafter these buttons are also referred collectively as the “Up/Down button”) of the remote controller 110 (FIG. 1) is depressed. If determined that the Up/Down button BUP, BDN is depressed, the process moves to Step S340a. If the Up/Down button BUP, BDN has not been depressed, the process advances to Step S320a.

In Step S320a, the HTTP browser 140 determines whether either the Right button BRG or the Left button BLF (hereinafter these buttons are also referred collectively as the “Right/Left button”) of the remote controller 110 (FIG. 1) is depressed. If determined that the Right/Left button BRG, BLF is depressed, the process advances to Step S330a. If the Right/Left button BRG, BLF has not been depressed, the process returns to Step S310a, and Steps S310a, S320a are executed repeatedly until the Up/Down button BUP, BDN is depressed.

In the event of a determination in Step S320a that the Right/Left button BRG, BLF is depressed, the HTTP browser 140 moves the character group in the input character box 500a (FIGS. 8(a)˜8(d)) depending on which button is depressed.

In the example of FIGS. 8(a)˜8(d), the user has pressed the Left button BLF of the remote controller 110 at some time between the states shown in FIG. 8 (a) and FIG. 8 (b). Consequently, the entire character group in the input character box 500a shifts leftward, so that the character group “Zz” on the left side now shifts to the right side. By so doing, the character group overlapping the input window 510a changes from “ABCDEabcde” to “FGHIJfghij.”

In the event of a determination in Step S310a of FIG. 7 that the Up/Down button BUP, BDN is depressed, in Step S340a, the character group to which the input character belongs is input. At this time, in order to prompt the user to select an input character in the character group, the input character box 500a begins to spin in the vertical direction. Subsequently, the character group selection subroutine shown in FIG. 7 terminates, and control returns to the character input routine of FIG. 6. In this way, in the second embodiment, the selected character group becomes the input character candidate displayed in the input window 510a.

The direction of spin of the input character box 500a is decided according to which button is depressed. Specifically, in the event that the button depressed by the user is the Up button BUP, the input character box 500a spins upward, whereas in the event that the depressed button is the Down button BDN, the input character box 500a spins downward. In the example of FIGS. 8(a)˜8(d), the user has pressed the Up button BUP of the remote controller 110 at some time between the states shown in FIG. 8 (b) and FIG. 8 (c). Consequently, the entire input character box 500a spins upward.

In Steps S400a˜S800a of FIG. 6, as in Steps S400˜S800 of the character input routine of the first embodiment shown in FIG. 3, processes such as acquiring an input character are executed. In the example of FIGS. 8(a)˜8(d), the Center button BCT of the remote controller 110 is depressed by the user at some time between the states shown in FIG. 8 (c) and FIG. 8 (d). Consequently, the letter “G” in the input window 510a is acquired as the input character, and is entered in the input field 450a.

In this way, in the second embodiment as well, the characters appearing in the input window 510a are cyclically switched by spinning the input character box 500a. The user may enter a desired character by pressing the Center button BCT during the time that the character appearing in the input window 510a is the character desired to input. Since the number of user's operations of the remote controller 110 in order to input characters can be reduced thereby, character input with the remote controller 110 becomes easier.

In the second embodiment, by selecting an input character candidate from among several character groups, it is possible to reduce the number of characters for display in the input window 510a. Consequently, for inputting characters from a large set of characters, such as letters of the alphabet or kana, the second embodiment is preferable to the first embodiment, since it may reduce the wait time until the input character box 500a spins and the desired character appears in the input window 510a. On the other hand, the first embodiment is preferable to the second embodiment in terms of the simplicity of the character input routine.

In the second embodiment, as shown in FIG. 7 and FIGS. 8(a)˜8(d), the character group is selected by depressing the Right/Left button BRG, BLF. It is also acceptable for the character group to be selected by some other method. For example, it is possible to select the character group appearing in the input window 510a when the Center button BCT is depressed by the user.

### C. Third Embodiment

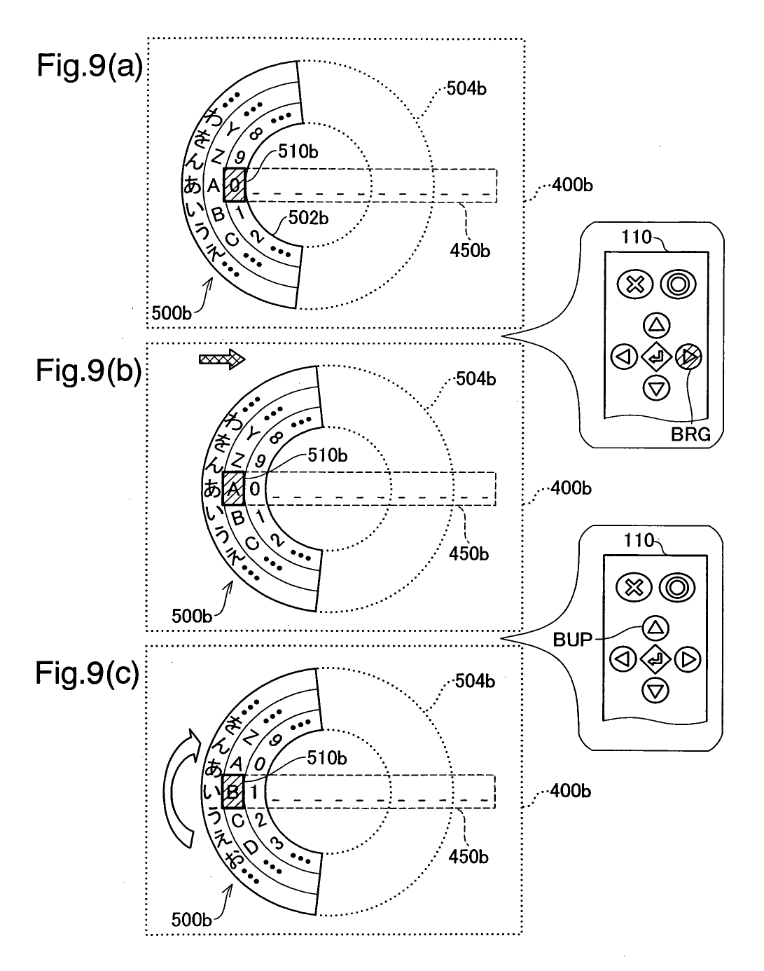

FIGS. 9(a) through 9(c) illustrate a situation while a character is input in the third embodiment. The input character box 500b shown in FIGS. 9(a)˜9(c) differs from that of the second embodiment in that the groups of characters for selection are divided into three sets of characters, namely numeric characters, alphabetical characters, and the hiragana characters; and in that the shape and character sequence are different. In other respects it is the same as the second embodiment.

As shown in FIG. 9 (a), in the third embodiment, the numeric, alphabetic, and hiragana character sets are arrayed in circular arrangement from the inward side towards the outward side of the input character box 500b. In the circular region of the input character box 500b, the characters of each character set are sequenced in dictionary order. Herein, dictionary order refers, in the case of numeric characters, to ascending order of the numerals; in the case of alphabetic characters, to alphabetical order; and in the case of hiragana characters to Japanese syllabary order.

While in the third embodiment the character groups are divided into the three sets of numeric characters, alphabetical characters, and hiragana characters, it would be acceptable to create more finely divided character groups for the alphabetical and hiragana characters. In this case, characters of each of the finely divided character groups would be displayed in circular regions of the input character box 500b.

In the input character box 500b, characters located towards the direction of the input window 510b on the left with respect to the center of the input character box 500b are set to higher brightness than at other locations. Characters decrease in brightness moving away from the direction of the input window 510b. Therefore, within the input character box 500b, in the area 502b enclosed by the solid lines it is easier to distinguish characters in the input character box 500b than characters in the input field 450b. In the area 504b enclosed by the dotted lines on the other hand, characters in the input field 450b are easier to distinguish than characters in the input character box 500b.

In the third embodiment, by pressing either the Right/Left button BRG, BLF, the user changes the positional relationship of the input character box 500b and the input window 510b, and selects as the input characters the set of characters in the circular area now overlapping the input window 510b. In the example of FIGS. 9(a)˜9(c), the user has depressed the Right button BRG of the remote controller 110 at a point in time between the states depicted in FIG. 9 (a) and FIG. 9 (b). Consequently, the position of the input character box 500b has shifted leftward from the state depicted in FIG. 9 (a), and the circular area overlapping the input window 510b is now the area in which the the alphabetical characters are displayed.

After selecting a character set in this way, when the user now depresses either the Up/Down button BUP, BDN, the input character box 500b spins around the center of the input character box 500b. In the example of FIGS. 9(a)˜9(c), the user has depressed the Up button BUP of the remote controller 110 at a point in time between the states depicted in FIG. 9 (b) and FIG. 9 (c). Consequently, the input character box 500b spins clockwise. In association with this spinning of the input character box 500b, the character appearing in the input window 510b changes. Thus, the user can input the desired character by depressing the Center button BCT at the point in time that the character appearing in the input window 510b is the desired character.

In this way, in third embodiment as well, the characters appearing in the input window 510a are cyclically switched by spinning the input character box 500a. The user may enter the desired character by depressing the Center button BCT at the time that the character appearing in the input window 510a is the desired character. Since the number of user's operations of the remote controller 110 in order to input characters can be reduced thereby, character input with the remote controller 110 becomes easier.

### D. Fourth Embodiment

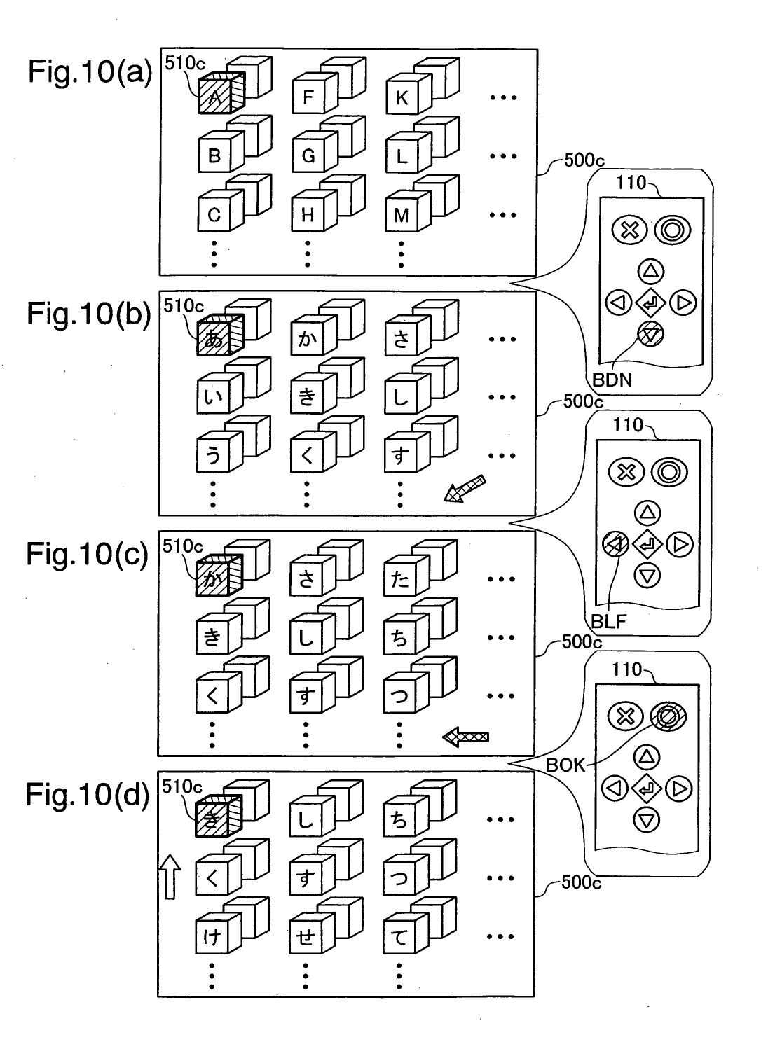

FIGS. 10(a) through 10(d) illustrate a situation while a character is input in the fourth embodiment. The input character box 500c shown in FIGS. 10(a)˜10(d) differs from that of the second embodiment in that the characters in the input character box 500c are arrayed three-dimensionally. In other respects it is the same as second embodiment.

As shown in FIG. 10 (a), the input character box 500c of fourth embodiment displays three-dimensional arrays of characters in perspective view format. The characters of alphabetic and hiragana character sets are arranged with each character set positioned at a given depthwise location. Character groups composed of characters of a given character set are arrayed in the horizontal direction, with the characters within character groups arrayed in the vertical direction. The input character box 500c has an input window 510c at a location at front upper left.

In the fourth embodiment, the user changes the character set displayed in the front of the input character box 500c by depressing either the Up/Down button BUP, BDN. In the example of FIGS. 10(a)˜10(d), the user has depressed the Down button BDN at a point in time between the states shown in FIG. 10 (a) and FIG. 10 (b). Consequently, in FIG. 10 (b), the character set at the front of the input character box 500c changes to hiragana positioned behind the alphabetic character set in FIG. 10 (a).

Character groups are selected by depressing either the Right/Left button BRG, BLF of the user. In the example of FIGS. 10(a)˜10(d), the user has depressed the Left button BLF at a point in time between the states shown in FIG. 10 (b) and FIG. 10 (c). Consequently, in FIG. 10 (c), the character group overlapping the input window 510c has changed from “a-i-u-e-o” to “ka-ki-ku-ke-ko.” When the user then depresses the OK button BOK, the character group overlapping the input window 510c will be selected.

Once a character group is selected, all of the characters displayed at the front of the input character box 500c begin to move. This moving of characteristics is carried out cyclically, with the characters in the uppermost row moving to the lowermost row. This moving of characteristics is carried out at intermittent intervals. Consequently, the user can enter a desired character by depressing the Center button BCT during the time that the character appearing in the input window 510c is the desired character.

In this way, in the fourth embodiment as well, the characters appearing in the input window 510c are cyclically switched. The user may enter the desired character by depressing the Center button BCT at the time that the character appearing in the input window 510c is the desired character. Since the number of user's operations of the remote controller 110 in order to input characters can be reduced thereby, character input with the remote controller 110 becomes easier.

### E. Fifth Embodiment

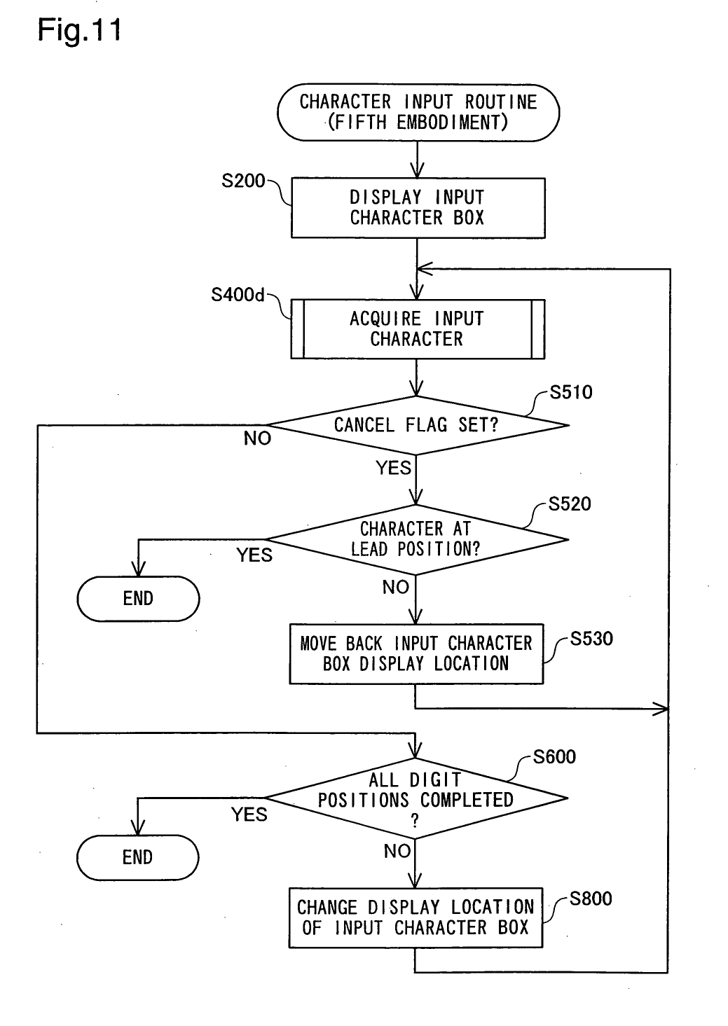

FIG. 11 is a flowchart of the character input routine in the fifth embodiment. The character input routine depicted in FIG. 11 differs from the character input routine of first embodiment depicted in FIG. 3 in that it includes additional Steps S510˜S530, and employs Step S400d instead of Step S400. In other respects it is the same as the first embodiment.

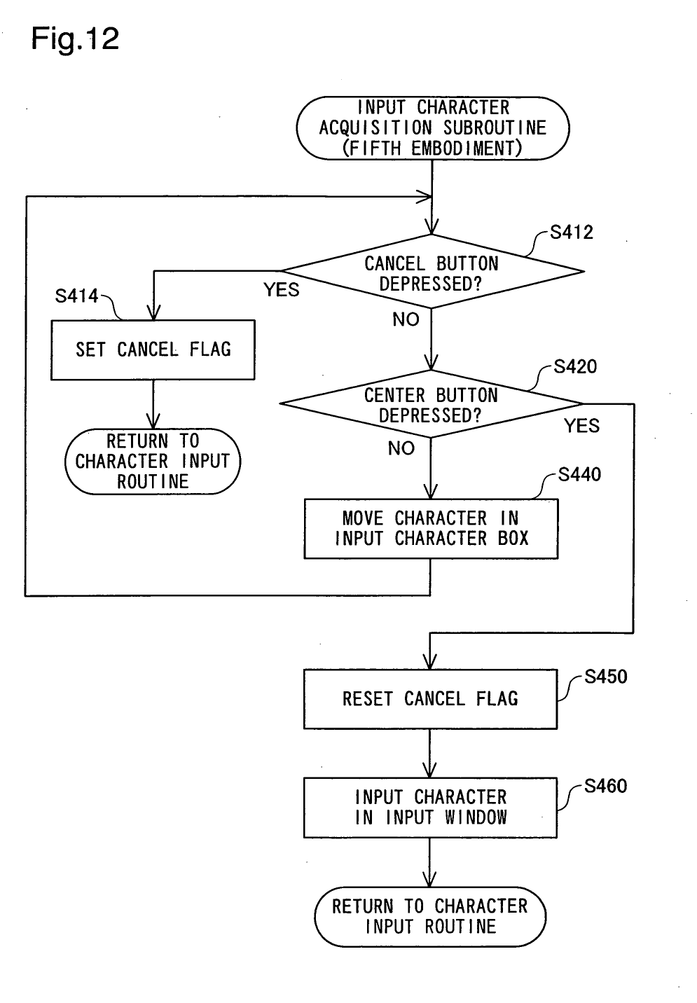

FIG. 12 is a flowchart depicting the input character acquisition subroutine in the fifth embodiment, which is executed in Step S400d of FIG. 11. The input character acquisition subroutine of the fifth embodiment depicted in FIG. 12 differs from the input character acquisition subroutine of the first embodiment depicted in FIG. 4 in that it includes three additional steps S412, S414, and S450. In other respects it is the same as the input character acquisition subroutine of the first embodiment.

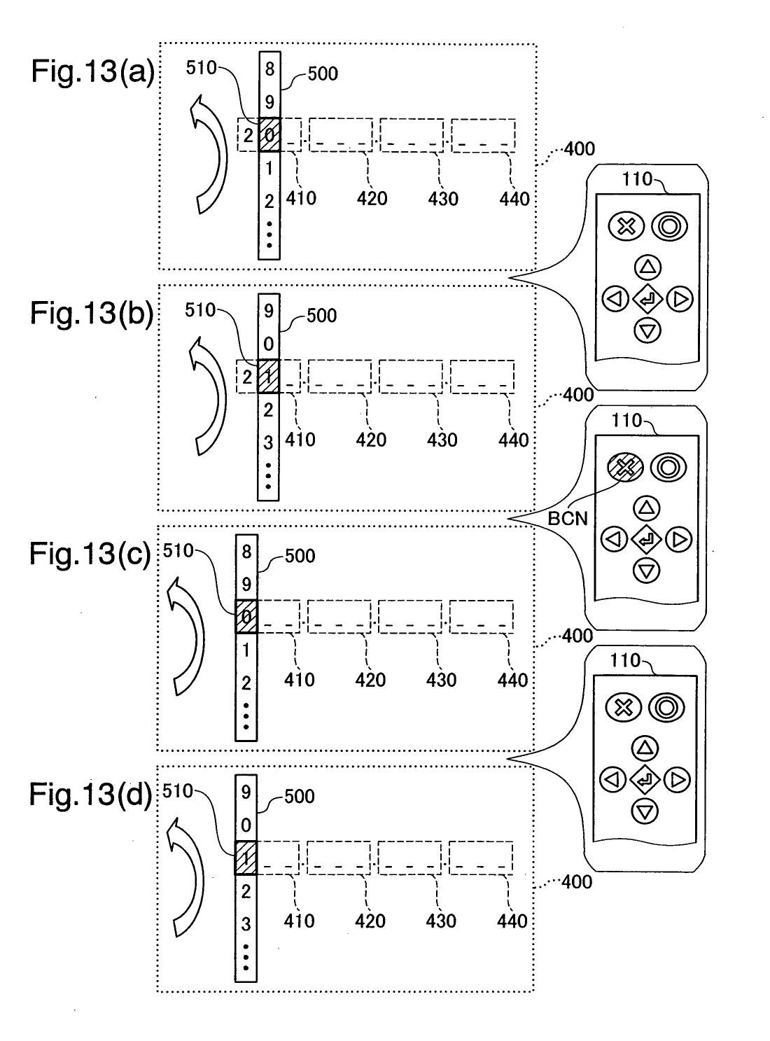

FIGS. 13(a) through 13 (d) illustrate changing of the character input location. FIG. 13 (a) is the same as FIG. 5(d), and depicts the state after the first digit of an IP address is entered.

In Step S412 of FIG. 12, the HTTP browser 140 determines whether the Cancel button BCN of the remote controller 110 (FIG. 1) is depressed. In the event of a determination that the Cancel button BCN has not been depressed, the process advances to Step S440. On the other hand, in the event of a determination that the Cancel button BCN is depressed, the process moves to Step S412. Then, in Step S412, a Cancel flag representing that the Cancel button BCN is depressed is set. After setting the Cancel flag in Step S412, the input character acquisition subroutine depicted in FIG. 12 terminates, and the process returns to the character input routine of FIG. 11.

In Step S450, the Cancel flag is reset. It is thus possible, when the input character acquisition subroutine depicted in FIG. 12 has terminated and control has returned to the character input routine of FIG. 11, to determine whether the Cancel button is depressed by the user.

In Step S510 of FIG. 11, the HTTP browser 140 determines whether the Cancel flag is set. In the event of a determination that the Cancel flag is set, i.e. that the input character acquisition subroutine (FIG. 12) is terminated by pressing the Cancel button BCN, the process moves to Step S520. On the other hand, in the event of a determination that the Cancel flag is not set, i.e. that the input character acquisition subroutine (FIG. 12) is terminated by pressing the Center button BCT, the process moves to Step S600.

In Step S520 the HTTP browser 140 determines whether the current character input location is the lead position in the character input field 410 (FIGS. 13(a)˜13(d)). In the event of a determination that the character input location is the lead position in the character input field 410 (FIGS. 13(a)˜13(d)), the character input routine of FIG. 11 terminates, and the IP address setting process is interrupted. On the other hand, in the character input location is not the lead position in the character input field 410, the process advances to Step S530.

In Step S530, the HTTP browser 140 moves the display position of the input character box 500 (FIGS. 13(a)˜13(d)) back by one digit position towards the lead position. By so doing, the position of the input window 510 in the input character box 500 corresponding to the character input location is moved back by one digit position towards the lead position, making it possible to change the previously input character.

In the example of FIGS. 13(a)˜13(d), the user has not performed any operation of the remote controller 110 during the time between the states depicted in FIG. 13 (a) and FIG. 13 (b). Consequently, the position of the input character box 500 in the sideways direction is unchanged between the states depicted in FIG. 13 (a) and FIG. 13 (b). Similarly, the position of the input character box 500 in the sideways direction is unchanged between the states depicted in FIG. 13 (c) and FIG. 13 (d).

During the time between the states depicted in FIG. 13 (b) and FIG. 13 (c), however, the user has depressed the Cancel button of the remote controller 110. Consequently, the position of the input character box 500 shown in FIG. 13 (c) is shifted back by one digit position towards the lead position (i.e. the first digit position of the character input field 410) from the position of the input character box 500 at the second digit position of the character input field 410 shown in FIG. 13 (b). Then, with the position of the input character box 500 moved back to the first digit position of the character input field 410, the user depresses the Center button BCT to re-enter a character at the first digit position of the character input field 410.

In this way, according to the fifth embodiment, by depressing the Cancel button BCN, the user may moves the character input location back towards the lead position of the character input field 410˜440. Then, by depressing the Center button BCT with the character input location moved back towards the lead position, a character can be re-entered at a digit position of a previously entered character.

### F. Variations

The invention is not limited to the embodiment discussed above, and may be reduced to practice in various other forms without departing from the spirit thereof, such as the following variations, for example.

### F1. Variation 1

In the embodiments hereinabove, characters displayed in the input character box are sequenced according a prescribed rule such as alphabetical order or Japanese syllabary order. It is also acceptable to employ any order for the sequence of characters displayed in the input character box. In such a case as well, the character displayed in the input window will change according to the character sequence in the input character field, so it will be possible for the user to anticipate the order of display of the characters switched through the input window and to instruct character input at the appropriate time.

### F2. Variation 2

In the embodiments hereinabove, multiple characters among the input character candidates are displayed on the character input page. It is also acceptable to dispense with display of the input character box. In such a case as well, the user will be able to input a desired character by instructing character input when the desired character appears as the character switched through the input window. In preferred practice, the order in which characters are displayed in the input window will be some prescribed order that enables the user to instruct character input at the appropriate time. It is possible for display of characters in the input window to be carried out, for example, in dictionary order such as alphabetical order or Japanese syllabary order, or in order of the character codes representing the characters.

### F3. Variation 3

In the embodiments hereinabove, the present invention is applied for performing setting of a network adapter 200 in a digital TV 100. Generally, the invention may be applied for inputting a character in any device that lacks a keyboard. The invention is able to be applied for inputting a character in a video game device, printer, multifunction device, and various other kinds of devices.

### F4. Variation 4

In the embodiments hereinabove, the character input routine is executed by the HTTP browser 140 of the digital TV 100 which executes an applet supplied from the HTTP server 242 of the network adapter 200. It is also possible for the character input routine to be executed by devices not connected to the network. In this case, the character input routine is executed by software stored on these devices.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method for inputting a character, comprising the steps of:
(a) displaying a character input screen on a display device, the character input screen having an input character selection field for showing one or more characters which are selectable to input a character;
(b) cyclically switching the one or more characters being displayed in the input character selection field;
(c) receiving a character input instruction from user; and
(d) acquiring the character being displayed in the input character selection field as an input character upon reception of the character input instruction.

2. A method for inputting a character according to claim 1, wherein
the switching of the one or more characters being displayed in the input character selection field is performed intermittently.

3. A method for inputting a character according to claim 1, wherein
the step (b) includes the step of switching the one or more characters displayed in the input character selection field in dictionary order of the characters.

4. A method for inputting a character according to claim 1, wherein
the step (b) includes the step of switching the one or more characters displayed in the input character selection field in order of character code of the characters.

5. A method for inputting a character according to claim 1, wherein
the step (b) includes the step of displaying in a prescribed order one of a plurality of pre-classified character groups.

6. A method for inputting a character according to claim 1, wherein the step (b) includes the steps of:
(b1) simultaneously displaying a plurality of characters as input character candidates in an input character display field that includes the input character selection field so that a single character among the input character candidates lies in the input character selection field; and
(b2) cyclically switching the one or more characters displayed in the input character selection field, by cyclically moving the plurality of characters displayed in the input character display field.

7. A method for inputting a character according to claim 6, wherein
the input character candidates constitute one of a plurality of pre-classified character groups, and
the step (b1) includes a step of displaying the characters belonging to each of the plurality of character groups to be arrayed in a first array direction, and arraying the plurality of character groups in a second array direction different from the first array direction.

8. A method for inputting a character according to claim 7, wherein
the step (b) further comprises the step of cyclically moving the character group displayed in the input character display field to change the input character candidates.

9. A method for inputting a character according to claim 7, wherein
the step (b) further comprises the step of changing positional relationship of the input character display field and the input character selection field while maintaining positional relationship of the input character display field and the character group displayed in the input character display field, thereby changing the input character candidates.

10. A method for inputting a character according to claim 1, further comprising the steps of:
acquiring display data representing the character input screen via a network, the display data including a computer program to execute the steps(a) through (d); and
executing the computer program included in the display data.

11. A device for inputting a character, comprising:
a character input screen display unit configured to display a character input screen on a display device, the character input screen having an input character selection field for showing one or more characters which are each selectable to input a character;
a selection field character switching unit configured to cyclically switch the one or more characters being displayed in the input character selection field;
a character input instruction receiving unit configured to receive a character input instruction from user; and
an input character acquiring unit configured to acquire the character being displayed in the input character selection field as an input character upon reception of the character input instruction.

12. A device for inputting a character according to claim 11, wherein
the selection field character switching unit intermittently switches the one or more characters being displayed in the input character selection field.

13. A device for inputting a character according to claim 11, wherein
the selection field character switching unit switches the one or more characters displayed in the input character selection field in dictionary order of the characters.

14. A device for inputting a character according to claim 11, wherein
the selection field character switching unit switches the one or more characters displayed in the input character selection field in order of character code of the characters.

15. A device for inputting a character according to claim 11, wherein
the selection field character switching unit displays in a prescribed order one of a plurality of pre-classified character groups.

16. A device for inputting a character according to claim 11, wherein the selection field character switching unit includes:
a character display field displaying unit configured to display simultaneously a plurality of characters as input character candidates in an input character display field that includes the input character selection field so that a single character among the input character candidates lies in the input character selection field; and
a display field character moving unit configured to cyclically switching the one or more characters displayed in the input character selection field, by cyclically moving the plurality of characters displayed in the input character display field.

17. A device for inputting a character according to claim 16, wherein
the input character candidates constitute one of a plurality of pre-classified character groups, and
the selection field character switching unit is configured to display the characters belonging to each of the plurality of character groups to be arrayed in a first array direction, and to array the plurality of character groups in a second array direction different from the first array direction.

18. A device for inputting a character according to claim 17, wherein
the selection field character switching unit further includes a display field character moving unit configured to cyclically move the character group displayed in the input character display field to change the input character candidates.

19. A device for inputting a character according to claim 17, wherein
the selection field character switching unit further includes a positional relationship changing unit configured to change positional relationship of the input character display field and the input character selection field while maintaining positional relationship of the input character display field and the character group displayed in the input character display field, thereby changing the input character candidates.

20. A device for inputting a character according to claim 11, further comprising:
a character input screen acquiring unit configured to acquire display data representing the character input screen via a network, the display data including a computer program to realize functions of the character input screen display unit, the selection field character switching unit, the character input instruction receiving unit, and the input character acquiring unit; and
a embedded program execution unit configured to execute the computer program.
